(19) United States
(12) Patent Application Publication
(10) Pub. No.: US 2015/0242921 A1
(43) Pub. Date: Aug. 27, 2015

(54) Web Based Method for Procuring a Customized First Aid Kit

(71) Applicant: Michael E. Peterson, Fairfield, CT (US)

(72) Inventor: Michael E. Peterson, Fairfield, CT (US)

(21) Appl. No.: 14/628,519

(22) Filed: Feb. 23, 2015

Related U.S. Application Data
(60) Provisional application No. 61/943,705, filed on Feb. 24, 2014.

(51) Int. Cl. G06Q 30/06

(52) U.S. Cl. CPC G06Q 30/0621; G06Q 30/0643

(57) ABSTRACT

A method for procuring a customized first aid kit having a case and multiple first aid items comprises displaying numerous web pages and making interactive selections based on the information accessed and displayed by said web pages. A kit size and a compliance standard or no compliance standard may be selected. A multiplicity of available first aid items is displayed on a website content page and various items are interactively selected from the content page. The final first aid kit is compiled in accordance with the various selections. The case for the first aid kit may also be specified from various possible materials as well as logos and color schemes for the first aid kit.

### CROSS-REFERENCE TO RELATED APPLICATION

This application claims the priority of U.S. Provisional Patent Application No. 61/943,705 filed on Feb. 24, 2014, the disclosure of which is incorporated by reference in its entirety.

### BACKGROUND

This disclosure relates generally to first aid kits and methods for compiling and assembling same. More particularly, this disclosure relates to methods for procuring first aid kits wherein the first aid kits, including the contents thereof, are customized for a specific customer.

### SUMMARY

Briefly stated, a method of procuring a customized first aid kit including a case and multiple first aid items is an interactive web-based method which encompasses the design of the case, the selection of the first aid contents and ensures compliance with regulatory standards. In a preferred form, the method comprises selecting a kit size from a web page having a plurality of possible sizes and selecting a compliance standard or no standard from a web page having a plurality of choices. The method further comprises displaying a multiplicity of available first aid items on a website content page and selecting items from the content page. The method comprises compiling a final first aid kit in accordance with the selection steps of selecting a kit size, selecting or not selecting a compliance standard and selecting items from the content page.

In one embodiment, the procurement method further comprises entering identifying information and customizing a label containing such information for the case. Material for the kit case is selected from a web page having a plurality of material choices. The method optionally allows for changing the kit size selected in the initial step of selecting a kit size. A web page is displayed indicating the selected first aid items and the first aid items available for selection. The procurement method is highly interactive to allow for selection changes during the process of compiling the first aid kit.

The interactive procurement method may also comprise obtaining a quote for the final selected first aid kit and entering the number of first aid kits to be procured.

The procurement method steps may also include displaying a multiplicity of available color code schemes on a color scheme website content page and selecting a color scheme from the color scheme content page.

The procurement method, in some embodiments, provides an interactive choice of supplementing, selecting or removing items in accordance with the selection of the kit size and selection of a compliance standard. A replenishment website content page is displayed providing for a replenishment option, and the procurement method may further comprise selecting a replenishment option from the replenishment website content page.

Some embodiments of the procurement method further enhance the selection capability by displaying a website content page for selecting a specific industry or usage requirement and thereby procuring a kit which complies with a specific industry or usage requirement. A jurisdiction website content page is optionally displayed which page has various jurisdictional requirement selection options and the procuring step further comprises selecting a kit which satisfies a jurisdictional requirement option from said jurisdiction website content page.

### BRIEF DESCRIPTION OF THE DRAWINGS

FIG. 1 is a representative screen which allows for the interactive selection of a kit size;

FIG. 2 is a representative screen, including a selection diagram, which allows for the interactive selection of a kit case material given a selected size;

FIG. 3 is a representative screen, including a selection diagram, which allows for the interactive initial selection of an empty or a pre-filled kit;

FIG. 4 is a representative screen which provides an overview of all items in the kit and the number of available units remaining to be filled in the kit as well as other options;

FIG. 5 are related screen portions of FIG. 4 which illustrate the interactive selection and adding and removal of kit contents;

FIG. 6 is a representative interactive screen which concerns selectively adding too many items to a kit;

FIG. 7 is an annotated representative interactive screen portion of FIG. 4 which allows the customer to switch to a different material kit;

FIG. 8 is a representative screen, partly diagrammatic, which facilitates and allows for the changing of the kit size;

FIG. 9 is a representative interactive screen relating to changing the quantity of kits;

FIG. 10 is a representative interactive screen, partly in diagram form, to provide for a custom branding of the kit;

FIG. 11 is a representative interactive screen which provides an overview of the kit and selected contents and further provides for various options as outlined; and

FIG. 12 is a workflow diagram which illustrates a method of compiling a first aid kit and illustrates the relationship between the screens and selections for the screens of FIGS. 1-11.

### DETAILED DESCRIPTION

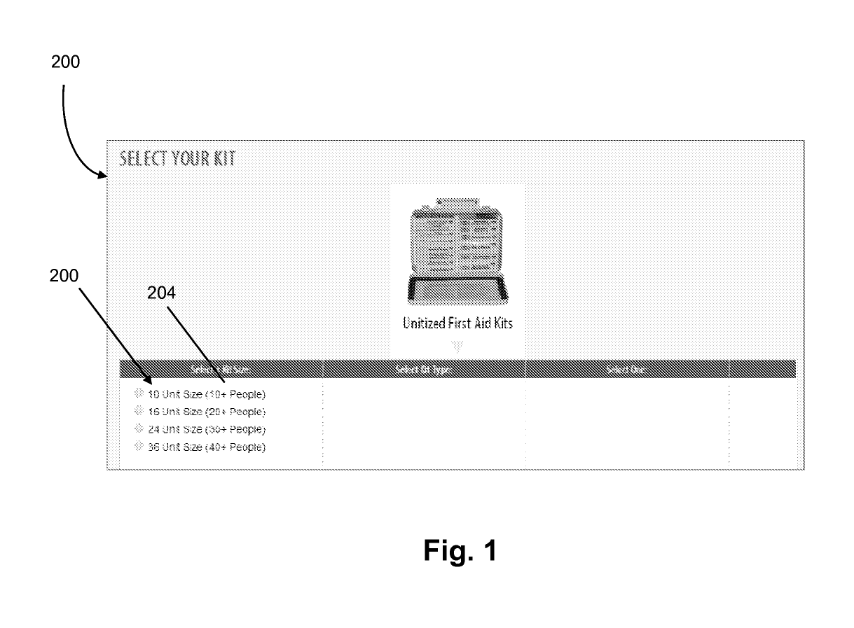

The method of selectively compiling a first aid kit involves a customer accessing a website and then being presented with a series of web page screens such as described in FIGS. 1-11. Various selections are made on each of the screens and the appropriate sequential screen is a function of one or more selections made by the customer. The method has the capability of accommodating a change of mind by the customer in the course of the selection process. The method also allows the customer to obtain detailed information on first aid items available for selection.

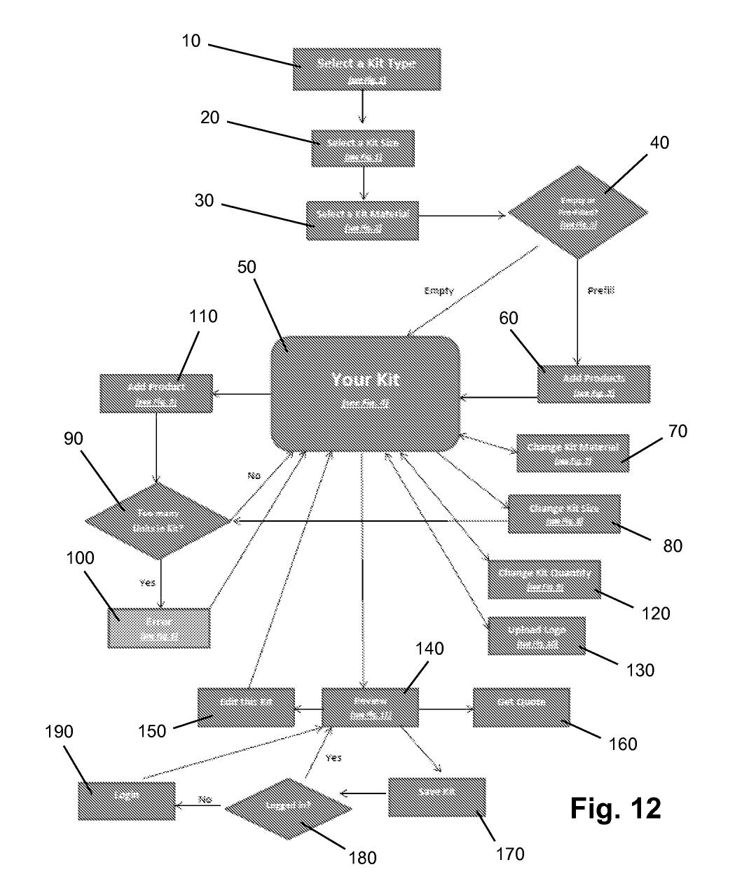

The method can best be initially appreciated by the workflow diagram illustrated in FIG. 12. A kit type is initially selected at 10. A kit size is then selected at 20. A material type for the kit case is then selected at 30.

A decision is then made by the customer at 40 as to whether the kit contents will be initially selected from an empty kit or a pre-filled kit in accordance with various recognized standards. If the kit is to be filled from an empty state, then the potential contents and options are indicated at 50. If the kit is to be pre-filled to satisfy a standard, then first aid items or products are added at 60, and the kit (which may now be partially or completely compiled) is viewed together with additional available products, if any, at 50.

The method also allows for changes to previous selections during the ongoing selection and compiling process. If the kit case material is to be changed at 70, the contents and the status are then viewed at 50. If the kit size is to be changed at 80, a test is made at 90 as to whether there are too many units in the kit. If so, an error is indicated at 100 and the status and available options are displayed at 50. If not, the customer returns at 50 to view the available first aid contents and the selected contents in the kit and options, and additional products are added at 110. Another test is then made at 90 to determine whether there are too many units in the kit given the selected kit parameters.

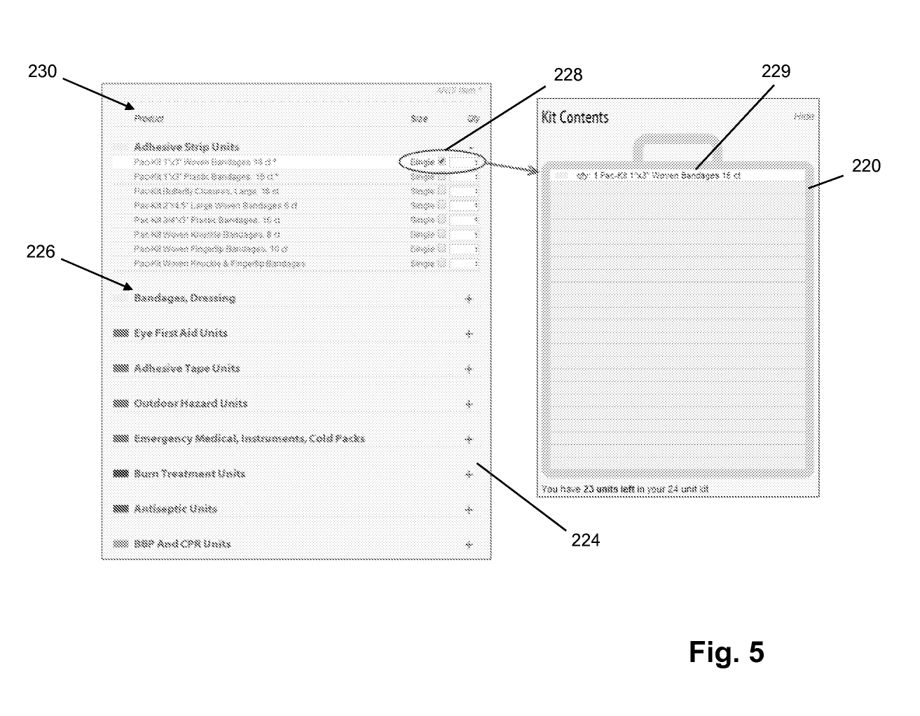

If the kit quantity is changed at 120, the contents available and selected for the kit are displayed at 50. If the kit is to be custom labeled as selected at the screen of FIG. 5, the logo may be added at step 130.

Finally, all of the contents of the kit are reviewed at 140. If necessary, the kit may be edited and the available contents and the selected contents of the kit may be viewed at 50. After the review, a quote may be obtained at 160. After review, the final kit description, including an inventory of selected contents, may also be saved at 170. A test is conducted at 180 as to whether the customer is logged in. If not, the customer is logged in at 190 and returned for review at 140. The kit description together with the relevant customer information is saved at 170.

Representation screens are described below in more detail. It should be appreciated that the screens may have newer other alternative forms and functions.

For step 10, the screen 200 of FIG. 1 is displayed and accessed by the customer. The unitized size is then selected at 202 from a listing 204 such as, for example, 8-, 10-, 16-, 24- or 36-unit sizes which relates to 10+, 20+, 30+ and 40+ people, respectively.

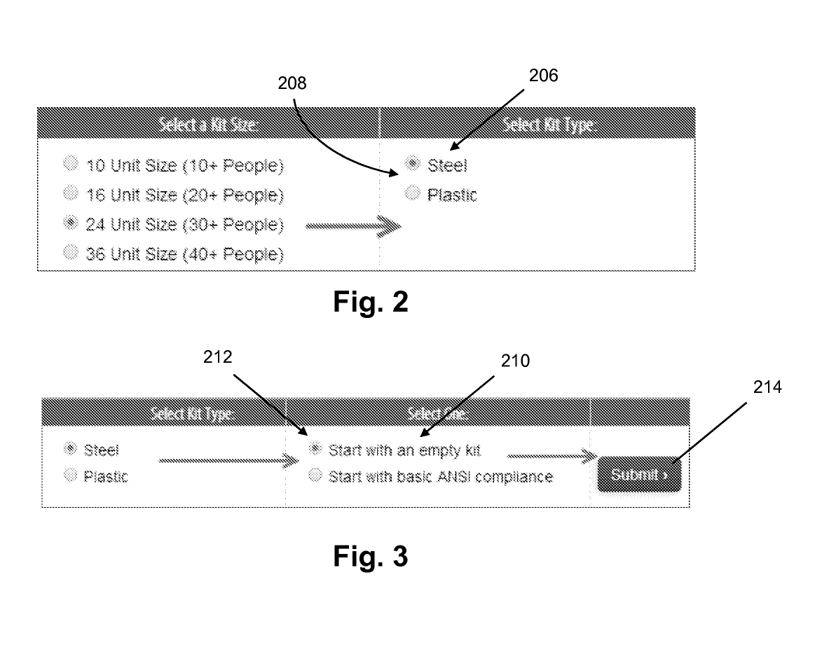

For step 20, the screen of FIG. 2 is displayed and accessed together with the previously selected unit size and a kit type 206. The kit type refers to the case and may be either steel or plastic, as selected at 208.

For step 30, the screen of FIG. 3 is displayed and accessed together with the previously selected kit type and a selection to start with an empty or basic ANSI compliance is selected at 212 and submitted at 214. For explanatory purposes a representative “24-unit size” kit with a “steel” case and an “empty” start has been selected.

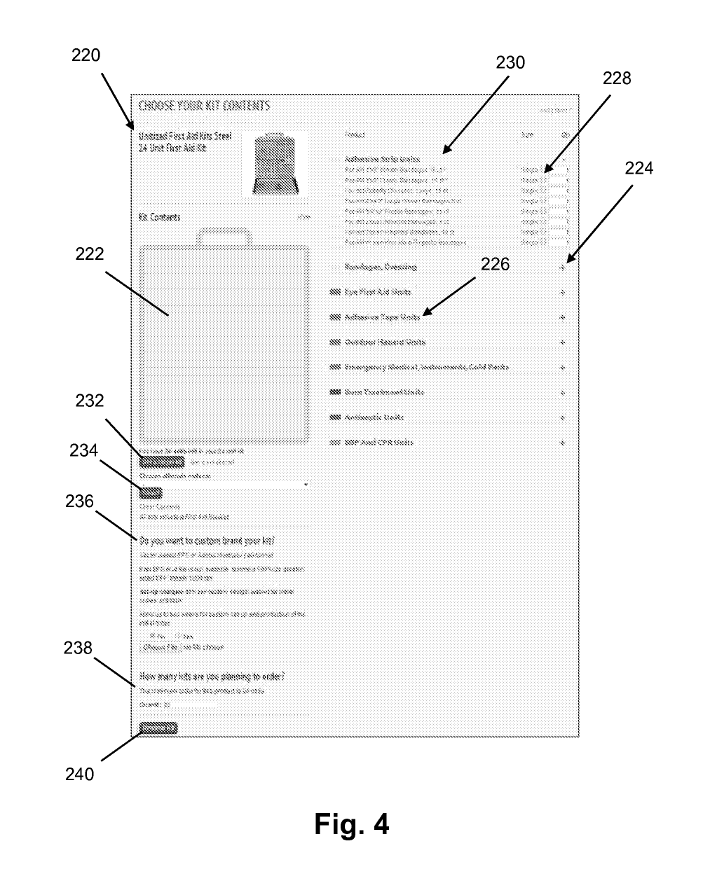

For step 40, the representative screen 220 of FIG. 4 is displayed and accessed by the customer. This screen illustrates the selected contents at 222 and also provides for the selection at 224 of various units 226, such as units of bandages and dressings, eye/first aid units, adhesive tape units, outdoor hazard units, emergency medical instruments, cold packs, burn treatment units, antiseptic units, BBP and CPR units as well as the selection at 228 of various adhesive strip units 230. Naturally, other available units are possible.

In addition, options may be selectively chosen at 232 for a larger kit, a different type of kit at 234 and choices are made as to whether the kit should contain a custom brand at 236 and the number of kits in the order at 238. The screen of FIG. 4 will be displayed many times throughout the method—depending on various decisions and selections—to essentially review at 240 the status of the kit as well as additional item options that can be added to the kit.

If first aid products are to be added at 60, the screen of FIG. 5 is displayed and accessed by the customer. The screen shows the adding and removing of contents displayed at 222 as well as allowing for specific products at 226 to be expanded for viewing additional details and collapsed within the products category. Product details may be accessed by moving a mouse pointer over any product, for example, to access a popover with a picture, product number and link to additional information. Key pad and voice activation may also be used to access additional information. The products may be selected using a corresponding selection box and/or quantity field 224, 228 next to each product to add it to or remove it from the kit. FIG. 5 shows a representative addition of a bandage unit 229 to the kit.

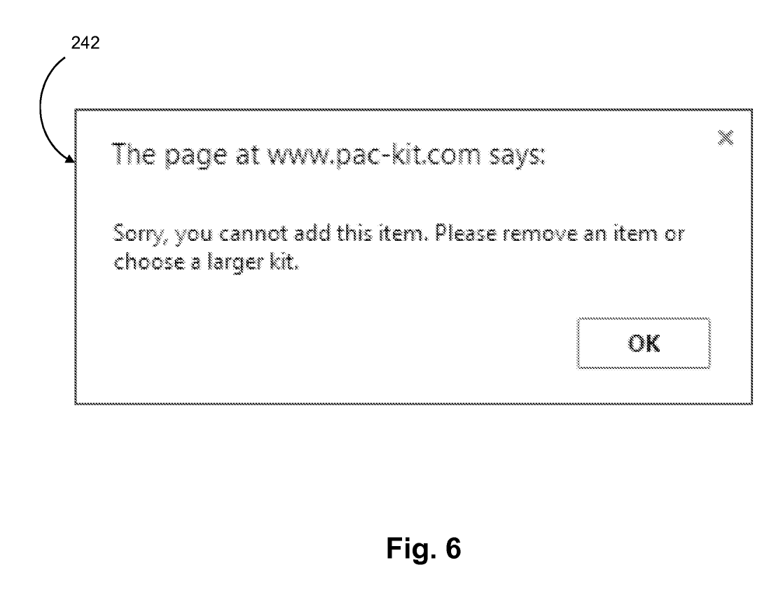

In the event that too many units have been added to a given selected kit as at list 90, an error, as indicated in FIG. 6, is displayed on the website indicating that the purchaser cannot add the desired item, and to indicate the item must be removed or a larger kit be obtained.

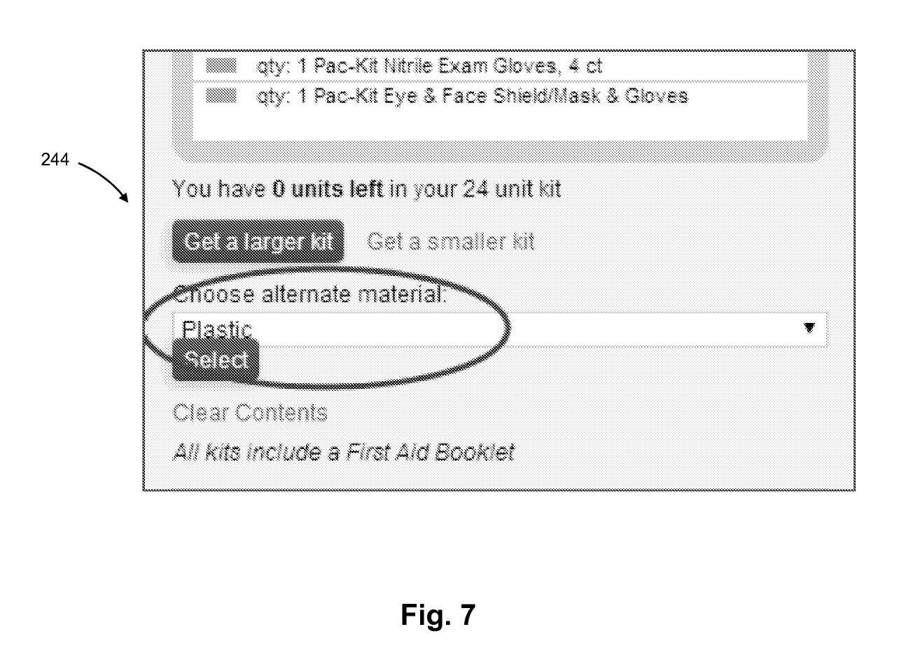

To change the kit case material as indicated at step 70, a screen is shown by the representative screen 244 of FIG. 7. The customer can then switch to a different case material using the drop down in the kit material section, and then clicking either selection when the customer has chosen the desired case material.

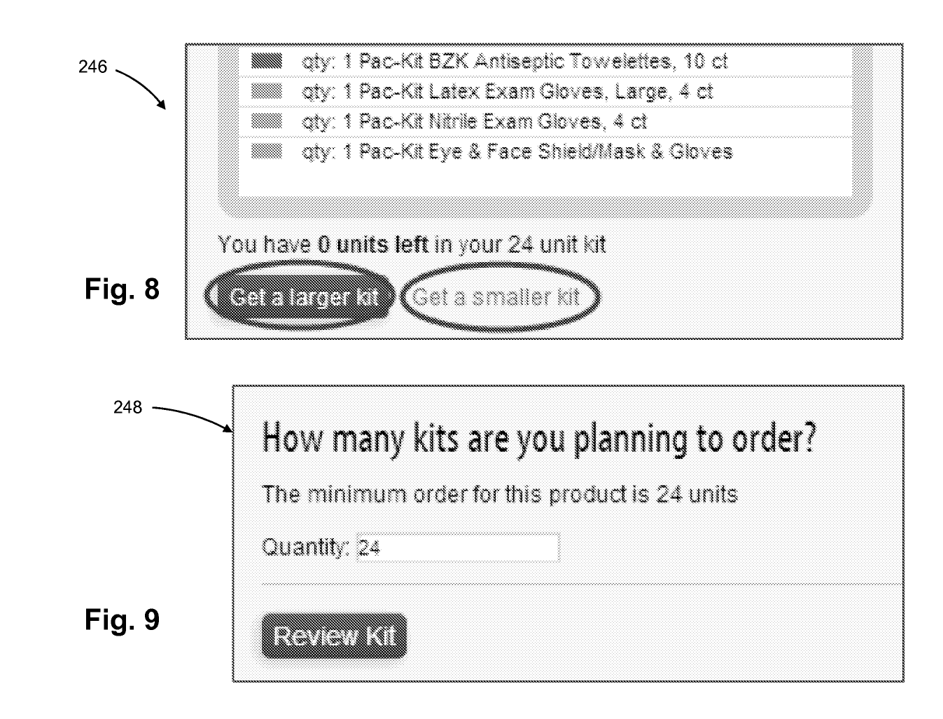

When the kit size is to be changed at step 80, the representative screen portion 246 of screen 220, as illustrated in FIG. 8, is displayed and accessed by the customer. The customer can then switch to a larger or smaller kit using the options in the kit size selection.

The kit quantity, i.e., number of kits ordered, can also be changed as at step 120 by reviewing the screen portion 248 as shown in FIG. 9. The customer can replace this number with the desired number of kits.

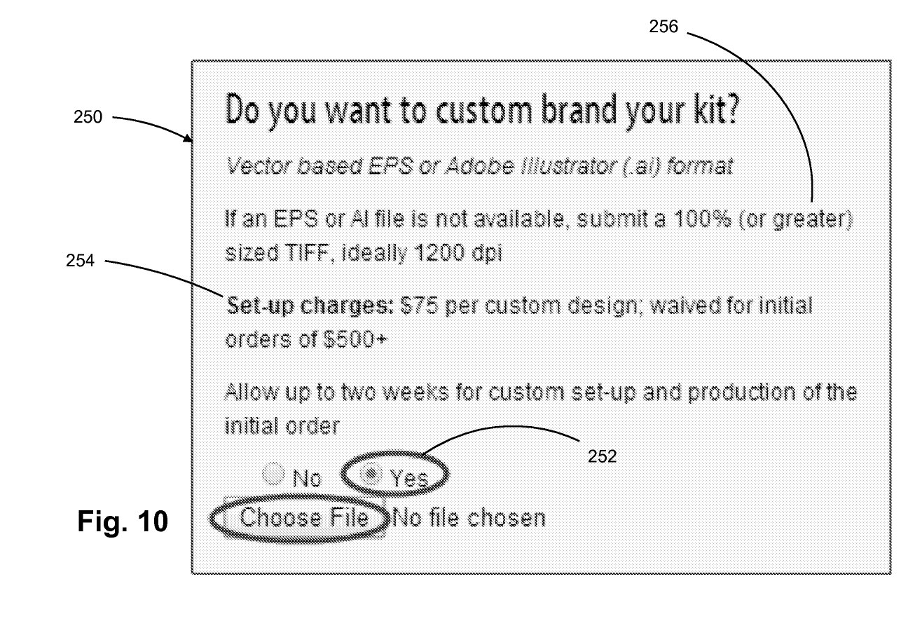

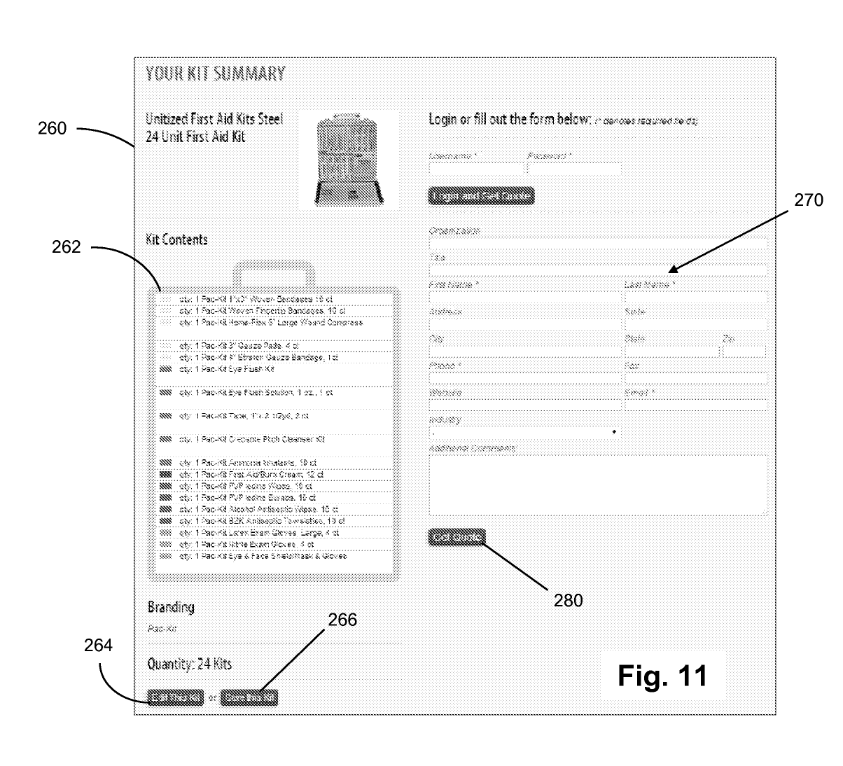

For the step of customizing the brand for the kit as selected in FIG. 4, a representative screen 250 such as that illustrated in FIG. 10 is displayed and accessed by the customer. A “yes” selection 252 may be made, and a logo may be uploaded at step 130. Various charges are indicated at 254. In addition, various other parameters 256 are indicated. In the event that it is desired to custom brand the kit, it is so indicated and a file is then selected.

The review page 260 for the review step at 140 is indicated in FIG. 11. The customer can review the kit and products selected at 262 and then choose various additional options. If the customer wishes to change the kit and/or products selected, the customer can click the “edit the kit” button 264 and return to the “your kit” screen 220 of FIG. 4.

If the customer desires to save the kit at 266 and return later to edit and/or request a quote, an account is required to utilize that option. The user selects the option at step 190 while logged in and the customer account page will display the created kit shown in the saved kit section. If the user selects this option while not logged in, the user will be prompted to log in or to create an account such as indicated at 270 of the screen of FIG. 11. After completing one of these actions, the customer account page will display that the customer has just created a kit shown in the “my saved kit” section.

If the customer is satisfied with the kit and products selected, the customer can request a custom quote from the “get quote” selection 280 of the screen of FIG. 11. However, if the customer is not logged in, the login fields will be displayed. If the customer has an account, the customer can log into the account and request a custom quote be automatically submitted.

If the customer does not have an account, the customer can fill out the form and click “get quote” 280 at the FIG. 11 screen to request the quote.

If the customer is logged in, the customer will only see the form on the right side of the page and it will be pre-populated with the relevant information. The customer can edit the fields as needed and then click “get quote” to submit the request for the quote.

Some embodiments of the web based method include various additional options which can be selected by the customer. In one embodiment, a screen is presented which includes various color scheme options, which may be selected for the case. At least some of the possible color scheme selections refer to various kit standards which, for example, are accomplished by a red or a green case color scheme.

A screen may also be presented and accessed by the customer to allow for the selection of either no or various content replenishment options. The selection capability allows the customer to select a replenishment program so that the entire set of contents or various individual contents will be automatically replenished at a future date. In some embodiments, the customer may select specific dates for automatic replenishment of the contents. The replenishment date for some contents may be determined by the useful life of the product.

Additional screens may also be provided and accessed by the customer to allow the customer to select a kit for a specific industry or application, such as, for example, a first aid kit for a school bus or a specific business or application, such as, for example, a first aid kit for a chemical lab. The screen or screens may also provide for a state-by-state, province-by-province or local selection so that the kit conforms to various legal jurisdiction or local requirements.

In another embodiment of the method, a screen is presented to allow for the customer to select compliance with various regional requirements, such as, for example, state laws which may regulate warnings on vinyl gloves or various OSHA standards. These regional requirements are various jurisdictions where the states, provinces or legal jurisdictions have requirements that apply for various contents of a first aid kit in terms of warnings, usages and maintenance, etc.

The procuring method also has application in conjunction with mobile devices as well as Google® Glass™ applications. For mobile devices, the application comprising the various screens and constructions can be downloaded. Once a final kit has been completed, the relevant information is transmitted to the host computer. The selections may be made by electronic pointers, key entries or voice communications. In addition, the sequence of screens may be generated by voice commands, touchpads or other means.

While preferred embodiments of the foregoing procuring method have been set forth for purposes of illustration, the foregoing description should not be deemed a limitation of the invention herein. Accordingly, various modifications, adaptations and alternatives may occur to one skilled in the art without departing from the spirit and the scope of the present invention.

1. A method of procuring a customized first aid kit having a case and multiple first aid items comprising:
(a) selecting a kit size from a web page having a plurality of sizes;
(b) selecting a compliance standard or no standard from a web page having a plurality of choices;
(c) accessing a display of a multiplicity of available first aid items on a website content page;
(d) selecting an item from the content page; and
(e) virtually compiling a final first aid kit in accordance with the selections of steps (a), (b) and (d);

2. The method of claim 1 further comprising entering identifying information and customizing a label containing such information for the case.

3. The method of claim 1 further comprising selecting a material for said kit case from a web page having a plurality of material choices.

4. The method of claim 1 further comprising changing the kit size selected in step (a).

5. The method of claim 1 further comprising accessing a web page indicating the selected first aid items and the first aid items available for selection.

6. The method of claim 1 further comprising obtaining a quote for the final first aid kit.

7. The method of claim 1 further comprising entering the number of first aid kits.

8. The method of claim 1 further comprising supplementing, selecting or removing the item of step (d) in accordance with the selection of steps (a) and (b).

9. The method of claim 1 further comprising accessing a display of a multiplicity of available color code schemes on a color scheme website content page and selecting a color scheme from the color scheme content page.

10. The method of claim 1 further comprising accessing a replenishment website content page which provides for a replenishment option and selecting a replenishment option from the replenishment website content page.

11. The method of claim 1 further comprising accessing a requirement website content page for selecting specific industry or usage requirements and selecting a kit from said requirement web content page which complies with a specific industry or usage requirement.

12. The method of claim 1 further comprising accessing a jurisdiction website content page which has various jurisdictional requirement selection options and comprising selecting a jurisdictional requirement option from said jurisdiction website content page.

13. A method of procuring a customized first aid kit having a case and multiple first aid items comprising:
(a) selecting a kit size from a web page having a plurality of possible sizes;
(b) selecting a compliance standard or no standard from a web page having a plurality of choices;
(c) accessing a display of a multiplicity of available first aid items on a website content page;
(d) selecting item from the content page;
(e) selectively changing the selected size of the kit of step (a) or selection of step (b) if the at least one selected item of step (d) is inconsistent with the selections of steps (a) and (b);
(f) repeating steps (c) and (d); and
(g) compiling a final first aid kit in accordance with the selections of steps (a), (b),(d) (e) and (f);

14. The method of claim 13 further comprising entering identifying information and customizing a label containing such information for the case.

15. The method of claim 13 further comprising selecting a material for said kit displaying first aid items required for said standard case from a web page having a plurality of material choices.

16. The method of claim 13 further comprising displaying a web page indicating the items included in a selected compliance standard and the selected first aid items and the first aid items available for selection.

17. The method of claim 13 further comprising obtaining a quote for the final first aid kit.

18. The method of claim 13 further comprising entering the number of first aid kits.

19. The method of claim 13 further comprising supplementing, selecting or removing the items of step (d) in accordance with the selection of steps (a) and (b).

20. The method of claim 13 further comprising displaying a multiplicity of available color code schemes on a color scheme website content page and selecting a color scheme from the color scheme content page.

21. A method of compiling customized first aid kit having a case and multiple first aid items comprising:
(a) displaying a kit size from a web page having a plurality of possible sizes and providing for interactive selection of a kit size;
(b) displaying a compliance standard or no standard on a web page having a plurality of choices and providing an interactive choice selection;
(c) if a compliance standard is selected, displaying on a website first aid items encompassed by said standard;
(d) displaying a multiplicity of available first aid items on a website content page and providing for an interactive selection of at least one first aid item;
(e) providing on a website an interaction capability of changing the selected size of the kit of step (a) or selection of step (b) if the selected item or items of step (d) are inconsistent with the selections of steps (a) or (b); and
(f) compiling a final first aid kit in accordance with the selections of steps (a), (b), (d) and (e);

22. The method of claim 21 further comprising displaying a replenishment website content page which provides for interactively selecting a replenishment option from the replenishment website content page.

23. The method of claim 21 further comprising displaying a requirement website content page for selecting specific industry or usage requirements and providing for interactively selecting a kit from said requirement web content page that complies with a specific industry or usage requirement.

24. The method of claim 21 further comprising displaying a jurisdiction website content page which has various jurisdictional requirement selection options and providing a jurisdictional requirement option for interactively selecting a jurisdiction requirement.
